(19) United States
(12) Patent Application Publication
(10) Pub. No.: US 2007/0014954 A1
(43) Pub. Date: Jan. 18, 2007

(54) Resin molded article and mold for manufacturing the same

(76) Inventor: Shinichi Yokoi, Uji (JP)

Correspondence Address: WENDEROTH, LIND & PONACK, L.L.P., 2033 K STREET N. W., SUITE 800, WASHINGTON, DC, 20006-1021, US

(21) Appl. No.: 11/180,645

(22) Filed: Jul. 14, 2005

(51) Int. Cl. B29C 47/00

(52) U.S. Cl. 428/36.9

(57) ABSTRACT

The invention provides a resin molded article and a mold for manufacturing the same, which can be entirely formed of resin by molding and no parting line occurs on a seal member support portion, wherein the shaft portion is formed by injection molding and a parting line is provided on the seal member except on the seal member support portion.

### BACKGROUND OF THE INVENTION

1. Field of the Invention

The present invention relates to a resin molded article having a cylindrical shaft portion that is supported while sealed by a sealing member, and particularly to a resin molded article such as a stirring screw or the like which is provided in a toner cartridge of an electrophotographic type copying machine or a printer, and a mold for manufacturing the resin molded article.

2. Description of the Related Art

As shown in FIG. 6, a stirring screw 200 is provided in a toner cartridge 100 of an electrophotographic type copying machine or a printer to stir toner in the cartridge as described in Japanese Published Unexamined Patent Publication No. 1995-253706.

As shown in FIG. 6 and FIG. 7, the stirring screw 200 includes a screw portion 210 having a screw 211 having a spiral or feathered shape at the center thereof, and shaft portions 220 at both ends thereof. Each shaft portion 220 is freely rotatably supported by a bearing portion of a casing 110 while it is engagedly fitted in a ring-shaped seal member (not shown). That is, the seal member is used to prevent toner from leaking through the gap between each bearing shaft portion 220 and the casing 110 as described in Japanese Published Unexamined Patent Publication No. 1996-190268.

The conventional stirring screw 200 is structured so that a metal sleeve 300 is engagedly mounted on the outer surface of a durability-required portion of the shaft portion 220 which is received by the bearing portion so that the shaft portion forming area of the resin stirring screw body 211 is surrounded by the metal sleeve 300 as shown in FIG. 7.

The stirring screw 200 is obtained by setting a metal sleeve 300 at a predetermined position inside the mold cavity and closing the mold to carry out injection molding of the stirring screw body 200. Accordingly, there is a problem that the manufacturing workability is low and costs are higher than molded articles formed of only resin. Furthermore, there has been proposed a mold in which a metal sleeve can be automatically set in a cavity, however, the apparatus itself is complicated and there is also a problem in manufacturing cost.

Therefore, the inventor of the present invention has considered that in the case of a stirring screw used for a toner cartridge of a compact printer or the like in which high durability is not truly required for the shaft portion thereof, the whole shaft portion is formed of resin together with the screw body by injection molding without using any metal sleeve.

A ring-shaped groove 221 in which an E ring for preventing the stirring screw 200 from dropping out is engagedly fitted is formed at the tip portion of the shaft portion 220 as shown in FIG. 7, and this groove 221 forms to an under cut. Accordingly, the mold must be normally designed in such a shape that it is divided by a line parallel to the center axis of the stirring screw 200.

Accordingly, when a conventional mold for injection molding is used, at the initial stage that the mold is manufactured, neither jounce nor abrasion occurs in the mold and also there is little problem in the parting line. However, when the injection is repeated many times, misalignment of the mold causes a step 400 in the parting line portion of the shaft portion 220 as shown in FIG. 8 or a burr 500 as shown in FIG. 9.

When a large step 400, burr 500 or the like as described above occurs on the surface of the shaft portion, the seal member is damaged by the corner portion of the step 400 or the burr 500 to lose sealing performance, and thus leakage of toner may occur.

Therefore, the present invention has been implemented in view of the foregoing situation, and has an object to provide a resin mold article which can be entirely molded by only resin and no parting line occurs in the shaft portion thereof, and a mold for manufacturing the resin mold article.

### SUMMARY OF THE INVENTION

In order to attain the above object, a resin molded article of the present invention has a cylindrical shaft portion, the shaft portion comprising a seal member support portion supported while sealed by a seal member and being formed by injection molding and a parting line exists outside the seal member support portion.

Furthermore, an application of the resin molded article of the present invention is not limited to a specific one, however, it may be applied to a stirring screw for a toner cartridge.

The resin used for the resin molded article is not limited to a specific one, however, polyester, polypropylene, polyethylene or the like may be used.

A mold for manufacturing a resin molded article, the resin molded article having a cylindrical shaft portion comprising a seal member support portion supported while sealed by the seal member and a groove being formed around the peripheral surface of the tip portion of the shaft portion, comprises a plurality of shaft portion tip forming slide molds that have a shaft portion tip cavity portion for forming the tip portion containing the groove formed portion of the shaft portion and are divided by a parting line passing through the center axis of the shaft portion, and a seal member supporting portion forming insert that has a cylindrical cavity portion for forming a part of the shaft portion which is sealed by at least a seal member and can be inserted and retracted between a molding position and a molded-article take-out position along the center axis of the cylindrical cavity portion under a state that the shaft portion tip forming slide mold is opened.

Furthermore, a mold for manufacturing a resin molded article having a cylindrical shaft portion, the cylindrical shaft portion comprising a seal member support portion supported while being sealed by a seal member and a groove being formed around the peripheral surface of the tip portion of the shaft portion, comprises a shaft portion forming insert having a cavity portion other than the area from a portion of the shaft portion which is sealed by at least a seal member to the groove-formed portion of the shaft portion tip portion, a plurality of divisional molds divided by a parting line passing through the center axis of the shaft portion, the divisional molds being slidably engaged in slide holes provided in the shaft portion forming insert, and groove forming slide molds forming a groove forming cavity portion under a close-contact state, wherein the shaft portion forming insert can be inserted and retracted between a molding position and a molded article take-out position under the state that the divisional molds of the groove forming slide molds are perfectly separated from the slide holes.

The resin molded article according to the present invention is entirely formed by injection molding as described above, and the parting line is provided outside of the seal member support portion. Therefore, even when jounce or abrasion occurs in the mold, the portion of the shaft portion which corresponds to the seal member is kept smoothened at all times. Accordingly, the seal performance of the seal member can be secured. Furthermore, the resin molded article can be formed by only injection molding without any metal sleeve, and thus the manufacturing cost can be reduced.

When a stirring screw of a toner cartridge is a resin molded article of the present invention, the cost of the toner cartridge can be reduced.

A manufacturing mold for the resin molded article according to the present invention has a shaft portion tip cavity portion for forming the tip portion containing the groove forming portion, the shaft portion tip forming slide molds comprising a plurality of divisional molds divided by a parting line passing through the center axis of the shaft portion, and the seal member support portion forming insert that has a cylindrical cavity portion for forming a portion of the shaft portion which is sealed by at least the seal member, and can be inserted and retracted between a molding position and a molded article take-out position along the center axis of the cylindrical cavity portion under the state that the shaft portion tip forming slide molds are opened, or the manufacturing mold comprises a shaft portion forming insert having a cavity portion other than the area from the portion of the shaft portion sealed by at least the seal member to the groove-formed portion of the tip portion of the shaft portion, and a plurality of groove forming templates that are divided by a parting line passing through the center axis of the shaft portion to form a small-diameter portion serving as the bottom of the groove under the close contact state, wherein the groove forming templates are freely slidably engaged with the slide holes provided in the shaft portion forming insert, a small-diameter forming cavity portion is formed under a close contact state that the groove forming templates are slidably engaged with the slide hole, and the shaft portion forming insert can be inserted and retracted between the molding position and the molded article take-out position under the state that the respective groove forming templates are perfectly separated from the slide holes. Accordingly, the resin molded article of the present invention can be manufactured with high yield.

### BRIEF DESCRIPTION OF THE DRAWINGS

FIG. 1 is a plan view showing the main part of a stirring screw of a toner cartridge which is an example of a resin molded article according to the present invention,

FIG. 2 is a cross-sectional diagram showing a series of moving steps of the main part at a side where the gate of a mold for manufacturing the stirring screw of the toner cartridge which is an example of the resin molded article according to the present invention is provided, wherein FIG. 2A shows a mold-closed state, FIG. 2B shows an open state of shaft portion tip forming slide molds, and FIG. 2C shows a state that a seal member support portion forming insert is slid to a molded article take-out position,

FIG. 3 is a cross-sectional view showing the motion of the shaft portion tip forming slide molds and a sprue portion of the mold of FIG. 2, wherein FIG. 3A shows a close-contact state, and FIG. 2B shows an open state,

FIG. 4 is a cross-sectional view showing the motion of the main part at a side where the gate of the mold of FIG. 2 is not provided, wherein FIG. 4A shows a mold-closed state before resin is filled, FIG. 4B shows a mold-closed state after resin is filled, FIG. 4C shows a state that the groove forming templates are opened, and FIG. 4D shows a mold-opened state,

FIG. 5 is a cross-sectional view of X-X line of FIG. 4, wherein FIG. 5A shows a mold-closed state, and FIG. 5B shows a mold-opened state,

FIG. 6 is a cross-sectional view showing an example of a conventional toner cartridge,

FIG. 7 is a plan view showing the main part of a conventional stirring screw,

FIG. 8 is a cross-sectional view of the shaft portion to show a state that a step occurs, and

FIG. 9 is a cross-sectional view of the shaft portion to show a state that a burr occurs.

### DETAILED DESCRIPTION OF THE PREFERRED EMBODIMENTS

The present invention will be described in detail with reference to the drawings showing embodiments thereof.

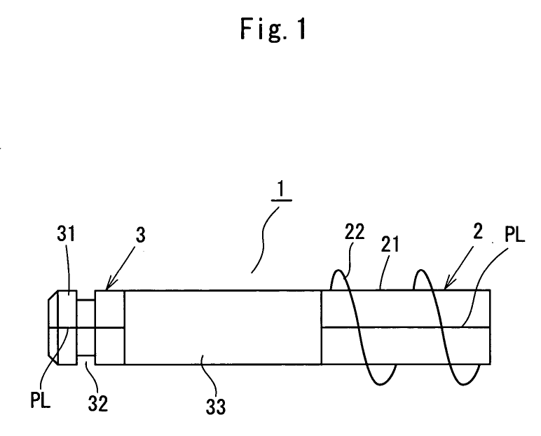

FIG. 1 is a stirring screw for a toner cartridge which is an example of a resin molded article according to the present invention.

As shown in FIG. 1, the whole stirring screw 1 is formed by injection molding, and shaft portions (illustrated at only one side in FIG. 1) 3 are provided at both ends of the screw portion 2.

The screw portion 2 has a cylindrical core portion 21 and a screw 22 which is spirally provided around the core portion 21.

A groove 32 in which an E ring (not shown) is engagedly fitted is formed at the tip portion 31 of the shaft portion 3.

The stirring screw 1 is designed so that the whole peripheral surface thereof is smoothened with no parting line on a seal member support portion 33 supported by a seal member (not shown) of the shaft portion 3, and a parting line PL parallel to the center axis of the stirring screw 1 is formed at the screw portion 2 and the tip portion 31 of the shaft portion 3.

As described above, in the stirring screw 1, no parting line is formed on the seal member support portion 33 of the shaft portion 3 which is supported by the seal member, and there occurs no projection such as a step caused by jounce of the mold, a burr caused by abrasion of the mold or the like in the seal member support portion 33 of the shaft portion 3 which is supported by the seal member.

Accordingly, even when all the parts containing the shaft portions 3 are formed of only resin, the seal member support portion 33 of the shaft portion 3 which is supported by the seal member can be manufactured while smoothened at all times, and the sealing performance of the seal member can be secured. In addition, since all the parts are formed of resin, productivity is high and the cost can be reduced.

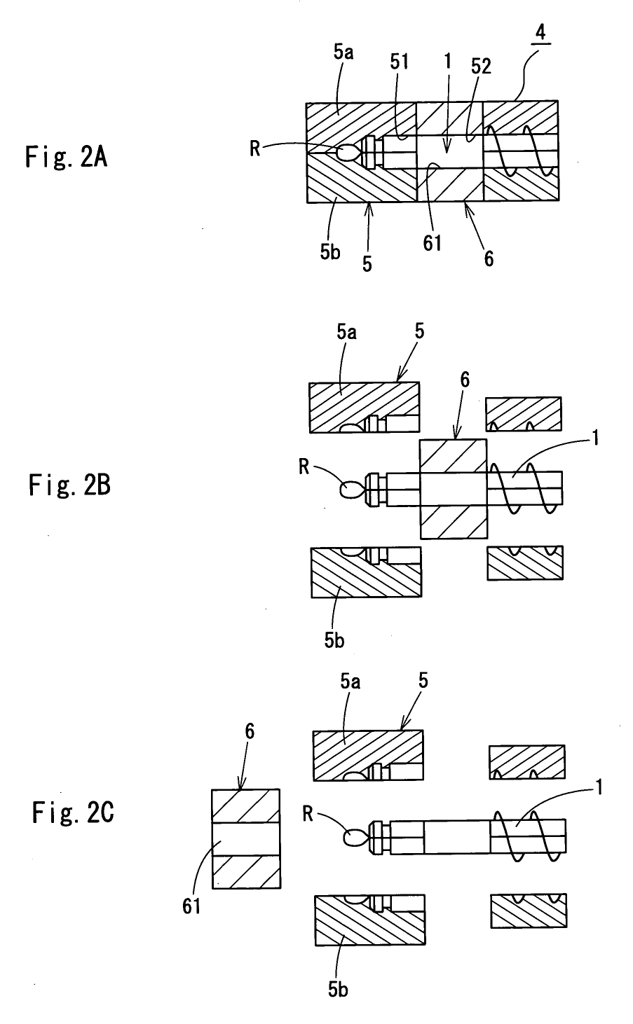

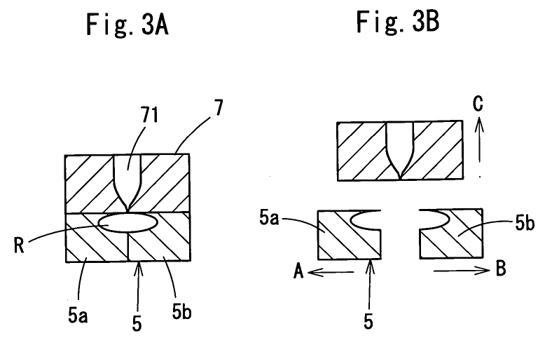

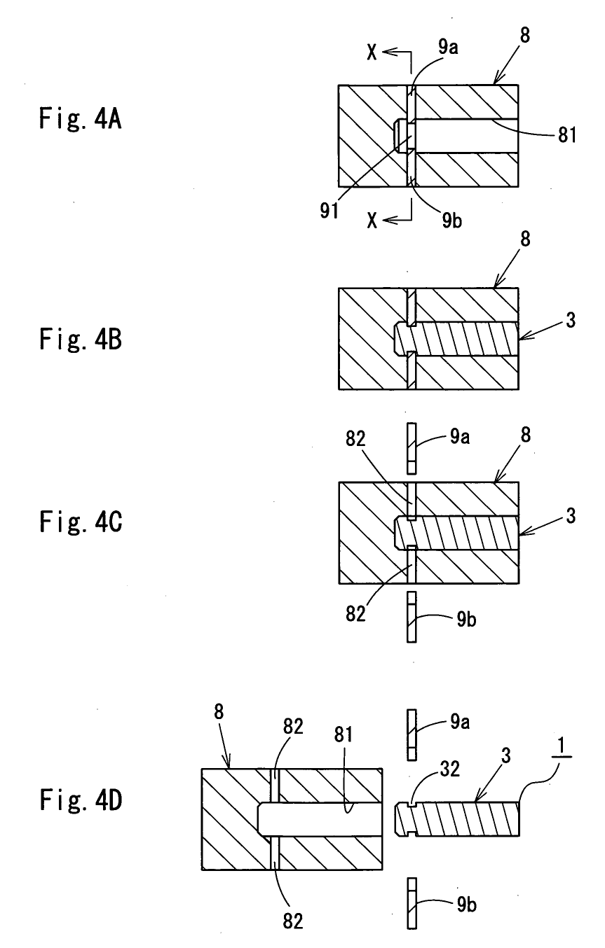

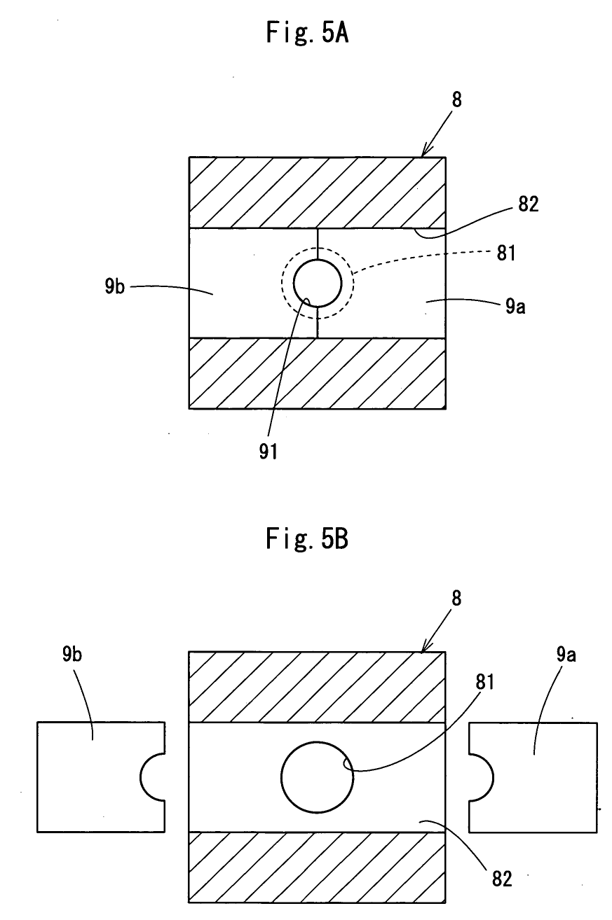

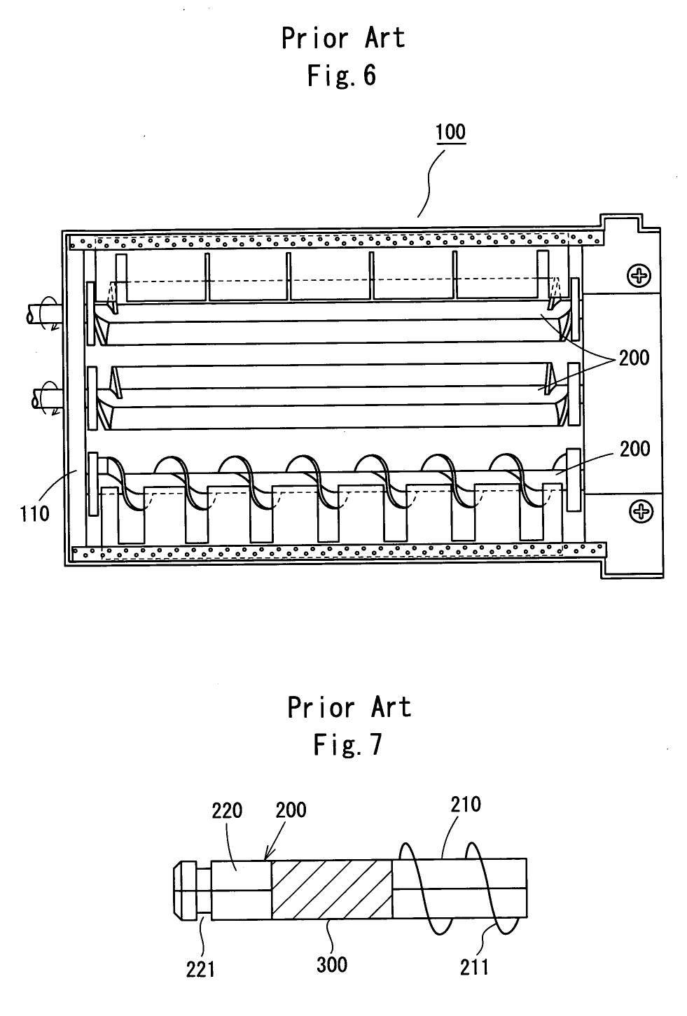

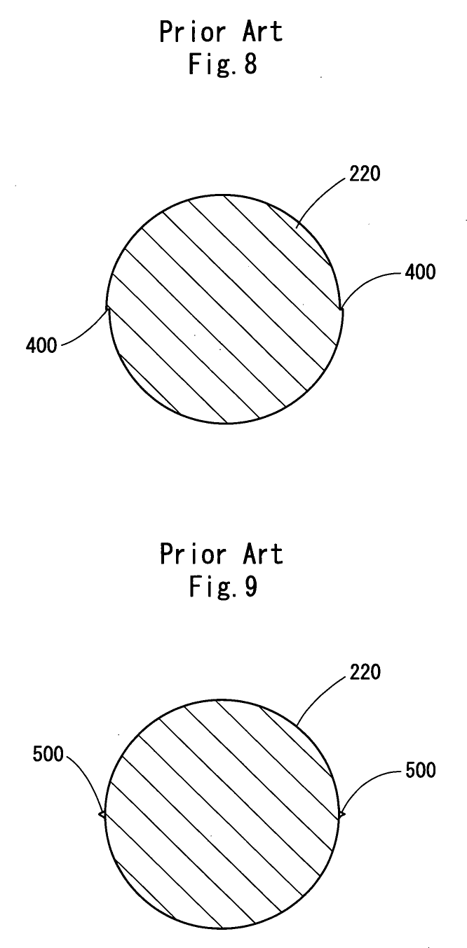

FIG. 2 shows a series of moving steps of main parts of the mold at the shaft portion forming portion at a side where the gate of the mold for manufacturing the stirring screw 1 is provided, FIG. 3 is across-sectional view showing a sprue portion of the manufacturing mold, and FIG. 4 and FIG. 5 are a series of moving steps of the main parts of the mold of the shaft portion forming portion at a side where the gate of the mold is not provided.

As shown in FIG. 2 to FIG. 5, the mold 4 comprises shaft portion tip forming slide molds 5, a seal member supporting portion forming insert 6, a sprue mold 7, a shaft portion forming insert 8, and two groove forming templates 9a and 9b.

As shown in FIG. 2 and FIG. 3, the two shaft portion tip forming slide molds 5 come into close contact with each other to form a shaft portion tip cavity portion 51 for forming the tip portion containing the groove-formed portion of the shaft portion 3, and pass through the center axis of the shaft portion 3. That is, the shaft portion tip forming slide molds 5 comprise two divisional molds 5a and 5b which are divided by a parting line for dividing the center axis of the shaft portion tip cavity portion 51.

The seal member supporting portion forming insert 6 has a cylindrical cavity portion 61 for forming the seal member support portion 33 of the shaft portion 3 which is sealed by at least the seal member. As shown in FIGS. 2B and 2C, the seal member support portion forming insert 6 can be inserted and retracted between a forming position shown in FIG. 2B and a molded-article take-out position shown in FIG. 2C along the center axis of the cylindrical cavity portion 61 under the state that the two divisional molds 5a and 5b of the shaft portion tip end forming slide molds 5 are opened.

From the close-contact state shown in FIG. 3A, the sprue mold 7 having the sprue 71 shown in FIG. 3 is moved so as to separate from the shaft portion tip forming slide molds 5 (in the direction of an arrow C) at the same time when the molding is finished and the shaft portion tip forming slide molds 5 are moved in an open direction (directions of arrows A, B) as shown in FIG. 3B.

The gate is designed as a pin gate type. In FIG. 2, R represents a runner, and it is removed after the molding is completed.

As shown in FIG. 4A, the shaft portion forming insert 8 and the two groove forming templates 9a and 9b have a cavity portion for forming the shaft portion 3 at the side where the gate of the stirring screw 1 is not provided when they are kept in close contact with each other. Furthermore, as shown in FIG. 4D, the shaft portion forming insert 8 has a cylindrical cavity portion 81 for forming the shaft portion 3 other than the groove-formed portion, and slide holes 82 are formed in the shaft portion forming insert 8 so that the groove forming templates 9a and 9b are slidably engaged with the groove 32 through the slide holes 82 as described later.

As shown in FIG. 4 and FIG. 5, each of the groove forming templates 9a and 9b is designed in such a bi-sectioned shape that it is divided by the parting line passing through the center axis of the shaft portion 3, and the groove forming templates 9a and 9b are slidably engaged with the slide holes 82 provided in the shaft portion forming insert 8 to thereby form a small-diameter portion forming cavity portion 91 under the close-contact state.

As shown in FIG. 4C, FIG. 4D and FIG. 5B, the shaft portion forming insert 8 is designed so that it can be inserted and retracted between the molding position shown in FIG. 4C and the molded-article take-out position of FIG. 4D under the state that the groove forming templates 9a and 9b are perfectly separated from the slide holes 82.

The present invention is not limited to the above embodiment. For example, in the above embodiment, the resin molded article is a stirring screw of a toner cartridge. However, it may be used as other stirring screws. Furthermore, in the above embodiment, only a spiral screw is formed around the core. However, many feathered projections may be provided, or the core may be provided with both the spiral screw and the feathered projections.

In the above embodiment, the shaft portion at the side where the gate of the mold is provided is formed by combining the shaft portion tip forming slide molds 5 and the seal member support portion forming insert 6, and the shaft portion at the side where the gate is not provided is formed by combining the shaft portion forming insert 8 and the groove forming templates 9a and 9b. However, the shaft portions at both sides may be formed by combining the shaft portion tip forming slide molds 5 and the seal member support portion forming insert 6. Furthermore, if the gate is provided to the screw body portion, the shaft portions at both sides may be formed by combining the shaft portion forming insert 8 and the groove forming templates 9a and 9b.

Furthermore, the divisional molds 5a and 5b and the groove forming templates 9a and 9b may be designed so as to be movable in the up-and-down direction of the mold or in the right-and-left direction of the mold.

What is claimed is:

1. A resin molded article having a cylindrical shaft portion, the cylindrical shaft portion comprising:
A seal member support portion supported by a seal member;
a groove formed around the peripheral surface of the tip portion of the shaft portion; and,
a parting line provided outside the seal member support portion,
wherein the whole of the resin molded article is formed by injection molding.

2. The resin molded article according to claim 1, wherein the resin molded article is a stirring screw of a toner cartridge.

3. A mold for manufacturing a resin molded article having a cylindrical shaft portion comprising a seal member support portion supported by a seal member and a groove formed around the peripheral surface of the tip portion of the shaft portion, comprising:
a shaft portion tip forming slide mold, consisting of a plurality of divisional molds divided by a parting line passing through the center axis of the shaft portion, that have a shaft portion tip cavity portion for forming the tip portion containing the groove formed portion of the shaft portion and;
a seal member supporting portion forming insert that has a cylindrical cavity portion for forming at least the seal member support portion,
wherein the seal member supporting portion forming insert is inserted and retracted between a molding position and a molded-article take-out position along the center axis of the cylindrical cavity portion where the shaft portion tip forming slide mold is opened.

4. A mold for manufacturing a resin molded article having a cylindrical shaft portion comprising a seal member support portion supported by a seal member and a groove formed around the peripheral surface of the tip portion of the shaft portion, comprising:
a shaft portion forming insert having a cavity portion for forming a portion other than the area from a seal member support portion supported by a seal member to the groove formed around the peripheral surface of the tip portion of the shaft portion; and
a plurality of groove forming templates that are divided by a parting line passing through the center axis of the shaft portion and forms a small-thickness portion serving as the bottom of the groove under a close contact state, wherein the groove forming templates are freely slidably engaged with slide holes provided in the shaft portion forming insert, forms a small-thickness portion forming cavity portion under a close contact state that the groove forming templates are slidably engaged with the slide holes, and can be inserted and retracted between a molding position and a molded article take-out position under a state that the respective groove forming templates are perfectly separated from the slide holes.
